(19) United States
(12) Patent Application Publication
(10) Pub. No.: US 2022/0082210 A1
(43) Pub. Date: Mar. 17, 2022

(54) METHOD AND FILLING DEVICE FOR FILLING A TRANSPORT TANK

(71) Applicant: LINDE GMBH, Pullach (DE)

(72) Inventors: Lutz DECKER, Winterthur (CH); Martin KNOCHE, Oberstammheim (CH); René MULLER, Droyssig (DE)

(21) Appl. No.: 17/310,346

(22) PCT Filed: Jan. 24, 2020
(86) PCT No.: PCT/EP2020/025029

§ 371 Date: Jul. 28, 2021

(30) Foreign Application Priority Data
Jan. 30, 2019 (GB) 1901254.1

(51) Int. Cl. F17C 6/00; F17C 5/04; F17C 7/02; F25J 1/00

(52) U.S. Cl. CPC F17C 6/00; F25J 2290/62; F17C 7/02; F25J 1/001; F25J 1/0025; F25J 1/005; F25J 1/0067; F17C 2205/0367; F17C 2221/012; F17C 2221/017; F17C 2223/0161; F17C 2223/033; F17C 2223/046; F17C 2225/0161; F17C 2225/033; F17C 2227/0135; F17C 2265/033; F17C 2265/061; F17C 2270/0134; F17C 2270/0171; F25J 2205/90; F25J 2240/60; F25J 2270/16; F25J 2290/60; F17C 5/04

(57) ABSTRACT

The present invention pertains to a method for filling a transport tank with a product medium in a liquid state in a gas liquefaction plant, comprising a step of supplying the product medium in the liquid state from a storage tank (18) of the gas liquefaction plant to the transport tank. The method is characterized in that it further comprises a step of discharging the product medium in a gaseous state from the transport tank into the storage tank (18).

### TECHNICAL FIELD

The invention relates to a method and a filling device for filling a transport tank with a product medium in a liquid state for use in a gas liquefaction plant.

### TECHNOLOGICAL BACKGROUND

In general, industrial gas liquefaction plants are known in which a feed gas stream, i.e. comprising hydrogen or helium, is cooled by means of a plurality of closed-loop cooling cycles to a temperature below a condensation point so as to provide a liquid product stream, i.e. comprising hydrogen or helium, in its liquid state.

For example, from EP 3 163 236 A1 an industrial hydrogen liquefaction plant is known which comprises a hydrogen cooling and liquefying unit, to which a hydrogen feed gas stream to be cooled is supplied. The hydrogen feed gas stream is usually produced outside the battery-limit of the plant, for example by means of a methane steam reformer or an electrolyzer.

Upon flowing through the hydrogen cooling and liquefying unit, the hydrogen gas stream is cooled to a temperature below its condensation point and thereby liquefied so as to generate a liquid product stream comprising hydrogen in its liquid state. In order to provide cooling energy required for cooling and liquefying the hydrogen gas stream, the hydrogen cooling and liquefying unit is thermally coupled to several cooling cycles by means of a plurality of heat exchangers.

Typically, the liquid product stream generated by the cooling and liquefying unit is supplied to a storage tank for storing the hydrogen with a storage pressure between 1 to 3.5 bar. For distribution purposes of the liquefied hydrogen, the known hydrogen liquefaction plants comprise filling stations for filling transport tanks with liquid hydrogen discharged from the storage tank.

In the context of the present disclosure, a transport tank generally refers to a mobile storage tank, e.g. used in freight transportation, for storing a product medium, i.e. comprising hydrogen or helium. Such transport tanks may be configured to be releasably coupled to filling stations of a gas liquefying plant to be filled with the product medium and/or to a vehicle, such as a train, truck, ship, etc., to be moved for distribution purposes or mobility for the vehicle itself. For example, the transport tank may be a tank trailer or a tank container for trucks, trains or ships.

Transport tanks usually warm up during their transportation or delivery to different customers, thereby causing a pressure increase within the transport tanks. Even after being discharged at a customer site, the transport tanks comprise residual liquid gas, for example hydrogen, in a pressurized state. The residual liquid gas in the transport tank warms up even more after delivery of the liquid gas to the customer, for example on the way back to the liquefaction plant. Before liquid gas, for example hydrogen, can be refilled in the transport tank at the liquefaction plant site, a pressure release has to take place by discharging the procedural and pressurized liquid gas from the transport tank. In known filling stations, the discharged liquid gas is subjected to a proper disposal by being combusted under controlled conditions or by being recycled to the suction side of the feed gas compressor.

### SUMMARY OF THE INVENTION

It is an object of the present invention to provide an improved method and an improved filling device for filling a transport tank with a product medium in a liquid state which enable to improve the overall efficiency of a gas liquefaction plant.

These objects are addressed by a method having the features of claim 1 and a filling device having the features of claim 9.

Accordingly, a method is provided for filling a transport tank with a product medium in the liquid state in a gas liquefaction plant, in which the product medium in the liquid state is supplied from a storage tank of the gas liquefaction plant to the transport tank. The method is characterized by comprising a step of discharging the product medium in a gaseous state from the transport tank to the storage tank.

As set forth above, transport tanks which return from a customer site after delivery, usually, comprise residual and pressurized product medium which has to be discharged before the transport tank can be refilled. The thus discharged product medium is also referred to as boil off gas.

According to the present invention, it has been found that the residual and pressurized product medium present in the transport tanks has an economic value, favorable material characteristics and an inner energy which currently, in the known gas liquefaction plants, are not or not sufficiently recovered.

For example, in case the product medium stored in the transport tank comprises hydrogen, the product medium, when being discharged from the transport tank, typically has a temperature below 31 K and a pressure up to 10 bar. Further, in case the product medium comprises hydrogen, it is characterized by a high fraction of para-hydrogen.

Thus, the present invention proposes to discharge the product medium in the gaseous state present in the transport tank, which may be a residual and pressurized product medium, to the storage tank, thereby returning it into the liquefaction process of the gas liquefaction plant. In this way, the proposed method enables to recycle both the product medium present in the transport tank itself as well as its inner energy, thereby increasing the overall efficiency of the gas liquefaction plant.

The gas liquefaction plant may be configured to generate the product medium in a liquid state and to supply the thus generated product medium to the storage tank. The product medium may comprise one or more cryogenic gases. Specifically, the product medium may comprise hydrogen. Accordingly, the gas liquefaction plant may be a hydrogen liquefaction plant. In the suggested method, the use of hydrogen as product medium may be particularly advantageous due to its two monomers of ortho- and para hydrogen, with their big difference in their enthalpy values. Alternatively, or additionally, the product medium may comprise helium or a mixture of helium and neon. Further, the product medium may comprise oxygen and/or other cryogenic gases.

For generating the product medium in the liquid state, the gas liquefaction plant may comprise a cooling and liquefying unit, to which a feed gas stream to be cooled is supplied. Upon flowing through the cooling and liquefying unit, the feed gas stream may be cooled to a temperature below its condensation point and thereby may be liquefied so as to generate a liquid product medium stream to be supplied to the storage tank. In order to provide cooling energy for cooling and liquefying the hydrogen gas stream, the hydrogen cooling and liquefying unit may be thermally coupled to one or more cooling cycles by means of a plurality of heat exchangers. The liquid product medium stream generated by the cooling and liquefying unit may then be guided into the storage tank such that the product medium in the liquid state is stored therein for further delivery, i.e. for being filled into the transport tank.

The basic structure of a gas liquefaction plant is well known to a person skilled in the art and is thus not further specified. Rather, characteristics of the gas liquefaction plant which are interlinked to the present invention are addressed in the following.

The storage tank may be configured to store the product medium, i.e. generated by the cooling and liquefying unit, in both a liquid and a gaseous phase. The storage tank is preferably provided with a storage volume that is greater, in particular several times greater, e.g. at least 5 or 10 times greater, than a storage volume of the transport tank. Further, the storage tank may be configured to store the supplied product medium at a storage pressure in the range of 1 to 6 bar, e.g. in the range of 1 to 3.5 bar. The product medium in the gaseous state that is discharged from the transport tank to the storage tank may have a temperature of 31 K or less and a pressure of 10 bar or less.

Upon discharging the product medium in the gaseous state from the transport tank to the storage tank, the storage pressure prevailing in the storage tank may increase. This may be achieved as the product medium is stored in the transport tank at a higher pressure level compared to the storage pressure of the storage tank. Due to the pressure increase in the storage tank induced by being supplied with the product medium from the transport tank, the process of filling the transport tank with the product medium in the liquid state from the storage tank may be improved. For example, with an increased storage pressure prevailing in the storage tank, a flow rate of the product medium supplied to the transport tank may be accordingly increased, thereby shortening the process time of filling the transport tank with the liquid product medium. In this way, both the product medium stored in the transport tank itself as well as its inner energy may be recovered.

In the method, the step of discharging the product medium in the gaseous state from the transport tank to the storage tank may be performed prior to and/or simultaneously with the step of supplying the product medium in the liquid state from the storage tank to the transport tank. Alternatively or additionally, the step of discharging the product medium in the gaseous state from the transport tank to the storage tank may be performed after the step of supplying the product medium in the liquid state from the storage tank to the transport tank.

The step of discharging the product medium in the gaseous state from the transport tank may be performed such that it is fed into the storage tank downstream of the cooling and liquefying unit of the gas liquefaction plant which generates the liquid product medium stream to be supplied to the storage tank. In this context, the terms “downstream” and “upstream” refer to a flow direction of the product medium, i.e. the feed gas stream and the liquid product medium stream, flowing through the cooling and liquefying unit.

In known hydrogen liquefaction plants, the feed gas stream, upon flowing through the cooling and liquefying unit, passes through multiple plate-fin heat exchanger passages filled with catalyst, typically hydrous ferric oxide, for enabling the ortho to para conversion of hydrogen. These multiple plate-for heat exchanger passages are also referred to as an ortho to para conversion section. Typically, the conversion of ortho to para hydrogen in the feed gas stream flowing through the cooling and liquefying unit, i.e. the respective heat exchanger, requires a considerable amount of cooling energy.

It has been further found, that, in case the product medium comprises hydrogen, the product medium stored in the transport tank typically comprises hydrogen with a high fraction of para-hydrogen, for example above 95%. Thus, as the product medium in the transport tank typically already has a high fraction of para-hydrogen, it is not required that the product medium discharged from the transport tank is guided through the cooling and liquefying unit, i.e. its ortho to para conversion section. Accordingly, by feeding the product medium in the gaseous state from the transport tank into the storage tank downstream of the cooling and liquefying unit, the above finding and thus the material characteristic of the product medium stored in the transport tank can be taken into account so as to provide a further optimized method for filling a transport tank. In this way, the product medium discharged from the transport tank can be prevented from being guided through the ortho to para conversion section of the cooling and liquefying unit, thereby increasing the overall efficiency of the process for liquefying and filling the product medium.

Alternatively, or additionally, the step of discharging the product medium in the gaseous state from the transport tank to the storage tank may be performed such that it is fed into the storage tank in its gaseous state. In other words, the product medium discharged from the transport tank enters the storage tank in its gaseous state.

As set forth above, the storage tank stores the product medium in both the liquid and the gaseous phase. In a further development, the step of discharging the product medium in the gaseous state from the transport tank to the storage tank may be performed such that the product medium in the gaseous state provided by the transport tank is fed into the liquid phase formed by the product medium in the liquid state stored in the storage tank. In other words, the product medium in the gaseous state provided by the transport tank is discharged into the storage tank such that it interfuses or pervades the liquid phase within the storage tank formed by the product medium in the liquid state. For doing so, the product medium in the gaseous state provided by the transport tank may be fed into the storage tank in an area, in particular in a bottom area of the storage tank, in which the liquid phase of the product medium within the storage tank is received or accommodated. Further, the product medium in the gaseous state may be fed into the storage tank such that it forms gas bubbles rising within the liquid phase in the storage tank.

With this configuration, the method may support a quick adjustment of a thermodynamic equilibrium within the storage tank which leads to a cooling and thereby re-liquefaction of the product medium provided by the transport tank. As the storage volume of the storage tank and accordingly the mass of liquid product medium stored therein is preferably several times larger than the storage volume of the transport tank and accordingly the mass of the gaseous product medium discharged into the storage tank, the storage tank is suitable to absorb and thus to dampen the peak of incoming heat from the product medium discharged from the transport tank. In other words, the storage tank provides a high cooling capacity enabling that the gaseous product medium from the transport tank may be discharged into the storage tank at high flow rates without excessively warming up the product medium stored in the storage tank. As a result, the method enables that the transport tank may be filled with the liquid product medium at short cycle times.

In order to make the process more efficient, the storage tank can be prolongated with a downward reaching pipe, thus increasing the height or thermodynamic exchange and the length of the mass transfer. Specifically, the downward reaching pipe may be provided with a cross-sectional area that is smaller compared to a cross-sectional area of the storage tank arranged above and particularly adjacent to the downward reaching pipe.

Further, as set forth above, the storage tank may be supplied with the liquid product medium stream generated by the cooling and liquefying unit. The liquid product medium provides a cooling of the product medium stored within the storage tank. By doing so, the gaseous phase within the storage tank successively condensates, while simultaneously the pressure in the storage tank may return to a desired pressure level, for example as prevailing in the storage tank prior to being feed with the product medium from the transport tank. In this way, the thermodynamic condition of the product medium stored within the storage tank can be adjusted for ensuring a proper operation.

For homogenously mixing the product medium in the gaseous state discharged from the transport tank with the product medium present in the storage tank, a static mixer may be provided. Specifically, the static mixer may be arranged within the storage tank such that the incoming gaseous product medium from the transport tank, upon being fed into the storage tank, is directed into the static mixer. Alternatively, the static mixer may be arranged at least partially outside the storage tank. Specifically, the static mixer may be configured for facilitating a bubble dispersion in the liquid hydrogen stored in the storage tank.

In general, a static mixer refers to a component for continuously mixing of fluid materials or streams, i.e. by creating turbulences therein. In such components, the mixing is induced by a loss in pressure as fluids flow through a mixer structure of the static mixer. For example, the mixer structure may be provided in form of a plurality of grid elements and/or a plurality of crossing channels and/or fins creating turbulences in a liquid.

Further, the static mixer may be configured and provided in the storage tank such that the product medium in the gaseous state supplied to the storage tank from the transport tank and the product medium in the liquid state supplied to the storage tank from the cooling and liquefying unit are fed into the static mixer and thereby are mixed. In this way, a homogenous mixing of the fluid components may be ensured, thereby accelerating the cooling and thus the condensation of the product medium in the gaseous state discharged into the storage tank. In addition, the adjustment of the thermodynamic equilibrium within the storage tank may be further accelerated.

Additionally or alternatively, the step of discharging the product medium in the gaseous state from the transport tank may be performed such that it is fed into the feed gas stream which, upon flowing through the cooling and liquefying unit, is to be liquefied so as to constitute the liquid product medium stream. By doing so, the product medium in the gaseous state discharged from the transport tank may be guided through the cooling and liquefying unit before being supplied to the storage tank.

Further, the product medium in the gaseous state may be fed into the feed gas stream downstream of a heat exchanger through which the feed gas stream is guided within the cooling and liquefying unit. For example, in case the product medium comprises hydrogen, the product medium in the gaseous state from the transport tank may be fed into the feed gas stream downstream of the ortho to para conversion section within the cooling and liquefying unit. In other words, the feed gas stream, into which the product medium in the gaseous state is fed, may comprise hydrogen which has already being subjected to a conversion of ortho hydrogen to para hydrogen upon flowing through the cooling and liquefying unit, i.e. the ortho to para conversion section.

For example, the product medium in the gaseous state from the transport tank may be fed into the feed gas stream via an ejector through which the feed gas stream is guided within the cooling and liquefying unit. Particularly, this is applicable if fueling time can be extended, i.e. to several hours. In the context of the present disclosure, an ejector refers to a pumping device, i.e. a fluid jet ejector, in which a pumping effect is generated due to an induced momentum transfer of a propellant medium to a suction medium, thereby accelerating and/or compressing the suction medium. In other words, an impulse is exchanged between a high velocity gas jet formed by the propellant medium and the suction medium fed in the ejector.

Typically, the ejector has a propellant inlet for receiving the propellant medium and a suction inlet for receiving the suction medium which, upon flowing through a suction chamber and a diffuser, are discharged via a fluid outlet. Accordingly, in the method, the product medium in the gaseous state discharged from the transport tank may be fed into the feed gas stream via the suction inlet of the ejector, wherein the feed gas stream may be guided into the ejector via the propellant inlet.

Additionally, or alternatively, the step of discharging the product medium in the gaseous state from the transport tank is performed such that it is fed into the liquid product medium stream. For example, the product medium in the gaseous state may be fed into the feed gas stream upstream of the storage tank and downstream of the cooling and liquefying unit.

Additionally, or alternatively, the step of discharging the product medium in the gaseous state from the transport tank is performed such that it is fed into a cooling cycle of the gas liquefaction plant.

The cooling cycle may be thermally coupled to the cooling and liquefying unit and may be configured to provide cooling energy for cooling and liquefying the feed gas stream flowing through the cooling and liquefying unit. The cooling cycle may be connected to the feed gas stream via a branch line so as to supply refrigerant circulating in the cooling cycle to the feed gas stream. The refrigerant circulating in the cooling cycle may comprise the product medium, e.g. hydrogen. In this way, the product medium in the gaseous state discharged from the transport tank may successively flow in the refrigerant stream through the cooling cycle, in a branch stream through the branch line, in the feed gas stream through the cooling and liquefying unit and in the liquid product medium stream so as to be supplied to the storage tank. Specifically, the product medium in the gaseous state discharged from the transport tank may be fed into the cooling cycle via a further ejector, through which the refrigerant circulates.

Accordingly, in the proposed method, the product medium in the gaseous state discharged from the transport tank may be fed into the cooling cycle via the suction inlet of the further ejector arranged in the cooling cycle, wherein the refrigerant circulating through the cooling cycle may pass the further ejector via the propellant inlet thereof.

Furthermore, a filling device for use in a gas liquefaction plant and for filling a transport tank with a product medium in a liquid state is provided. The filling device may be particularly used to carry out the above described method for filling a transport tank. Accordingly, technical features which are described in connection with the method for filling a transport tank may also relate and be applied to the filling device, and vice versa.

The filling device has a supply line for supplying the product medium in the liquid state from a storage tank of the gas liquefaction plant to the transport tank and is characterized in that it further comprises a feed line for discharging the product medium in a gaseous state from the transport tank to the storage tank.

The feed line may be configured to feed the product medium in the gaseous state provided by the transport tank into the storage tank downstream of a cooling and liquefying unit of the gas liquefaction plant which is configured to generate a liquid product medium stream to be supplied to the storage tank.

Alternatively or additionally, the feed line may be configured to feed the product medium in the gaseous state provided by the transport tank into the storage tank in its gaseous state. In this configuration, the storage tank may be configured to store the product medium in both a liquid and a gaseous phase, wherein the feed line may be configured to open into the storage tank such that the product medium in the gaseous state is fed into the liquid phase of product medium stored in the storage tank. In other words, the feed line may open into the storage tank in an area, in particular a bottom area or even a downward prolongation, e.g. the downward reaching pipe, in which the liquid phase formed by the product medium in its liquid state is accommodated or stored within the storage tank.

Further, a static mixer may be provided, which is configured to receive the product medium in the gaseous state discharged from the transport tank via the feed line and to mix it with the product medium in the liquid state stored in the storage tank. Particularly, the static mixer may be accommodated at least partially in the storage tank, in particular in a storage space thereof, and/or upstream of the storage tank, e.g. in the feed line. For example, the static mixer, at least partially, may be accommodated in the downward reaching pipe. Further, the static mixer may be configured to receive and mix the product medium in the gaseous state supplied to the storage tank from the transport tank via the feed line with the product medium in the liquid state supplied to the storage tank from the cooling and liquefying unit. Specifically, the product medium in the liquid state may be supplied to the storage tank from the cooling and liquefying unit via a liquid product line, which may open into the storage tank in an area, i.e. a ceiling area, in which the gaseous phase formed by the product medium in the gaseous phase within the storage tank is received.

As set forth above, the static mixer is provided with a mixer structure, e.g. a corrugated structure, for creating turbulences in a liquid flowing therethrough, thereby mixing the liquid. The mixer structure may be provided in form a grid structure and/or a plurality of crossing channels enabling to, within the storage tank, mix the product medium in the gaseous state discharged from the transport tank with the product medium in the liquid state present in the storage tank. Upon flowing through the mixer structure, the mediums to be mixed are subjected to shear forces which prevent or eliminate coalescence.

The mixer structure may be accommodated within a housing of the static mixer, wherein the housing is provided with a first feed opening for feeding the product medium in the gaseous state discharged from the transport tank into the static mixer, a second feed opening for feeding the product medium in the liquid state supplied to the storage tank from the cooling and liquefying unit into the static mixer, and/or at least one outflow opening. The outflow opening may be configured for discharging a mixed stream, i.e. a liquid mixed stream, formed by the product medium in the liquid state and the gaseous state upon flowing through the mixer structure.

Specifically, the housing of the static mixer may have a tubular shape in which at least one end face thereof forms the first and/or the second feed opening. For example, the static mixer may be provided such that opposing end faces of the housing form the first feed opening and the second feed opening. Further, the at least one outflow opening is provided in a shell surface of the housing, in particular between the first and the second feed opening. The at least one outflow opening may be provided in form of a plurality of through holes. The plurality of through holes may be regularly distributed along the shell surface of the housing. The at least one outflow opening may be provided such that the liquid stream guided through the at least one outflow opening causes convection within the liquid and/or gaseous phase in the storage tank.

The static mixer may be arranged in an upright position within and/or outside of the storage tank such that the first feed opening is arranged underneath the second feed opening. Further, the storage tank may be also arranged in an upright position. In this context, an upright position means that a component is arranged such that its length of extension in a vertical direction is larger than its length of extension in a horizontal direction. By such a configuration, a mass transfer area of the static mixer provided by the conjugated structure for mixing the supplied product medium streams may be increased, thereby improving the effectiveness of the static mixer. Alternatively, the storage tank may be arranged in horizontal position in which its length of extension in the vertical direction is smaller than its length of extension in the horizontal direction.

By using the static mixer, a compact and effective means is provided for mixing the product medium streams supplied into the storage tank. Specifically, due to the mixer structure, a large mass transfer area may be provided in a small amount of space. Further, such a mixer has low energy and low maintenance requirements. The static mixer may also serve as a limiter for pressure release.

Alternatively, or additionally, the feed line may be configured to feed the product medium in the gaseous state provided by the transport tank into a feed gas stream of the cooling and liquefying unit which, upon flowing through the cooling and liquefying unit, is to be liquefied and supplied to the storage tank.

Alternatively, or additionally, the feed line may be configured to feed the product medium in the gaseous state provided by the transport tank into a cooling cycle of the gas liquefaction plant for providing cooling energy for cooling and liquefying the feed gas stream flowing through the cooling and liquefying unit. In particular, the cooling cycle may be connected to the feed gas stream via a branch line so as to supply a refrigerant circulating in the cooling cycle and comprising the product medium to the feed gas stream.

### BRIEF DESCRIPTION OF THE DRAWINGS

The present disclosure will be more readily appreciated by reference to the following detailed description when being considered in connection with the accompanying drawings in which:

FIG. 1 is a schematic thermodynamic process diagram illustrating an industrial hydrogen liquefaction plant with a filling device for carrying out a method of filling a transport tank according to the present invention.

FIG. 2 is a schematic cross-sectional view on a storage tank of the hydrogen liquefaction plant as depicted in FIG. 1.

### DETAILED DESCRIPTION OF PREFERRED EMBODIMENTS

In the following, the invention will be explained in more detail with reference to the accompanying figures. In the figures, like elements are denoted by identical reference numerals and repeated description thereof may be omitted in order to avoid redundancies.

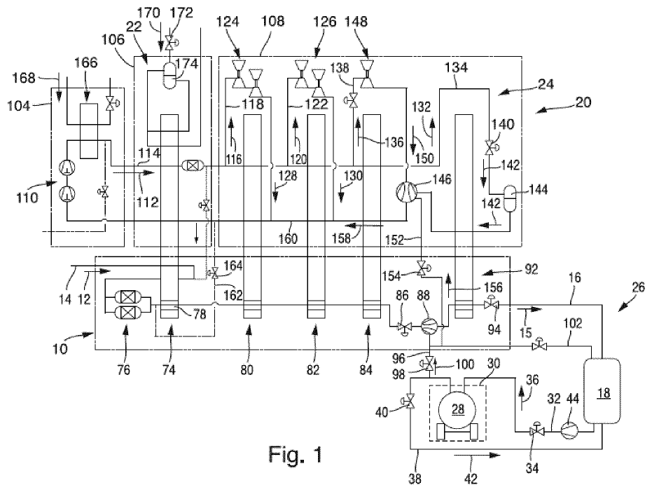

FIG. 1 depicts a process design for an industrial hydrogen liquefaction plant for hydrogen liquefaction on a large-scale. The hydrogen liquefaction plant comprises a hydrogen cooling and liquefying unit 10, to which a feed gas stream 12 comprising hydrogen is supplied via a feed gas line 14. Upon flowing through the cooling and liquefying unit 10, the hydrogen feed gas stream 12 is cooled and thereby liquefied so as to generate a liquid product stream 15 which is supplied via a liquid product line 16 to a storage tank 18 for collecting and storing liquefied hydrogen. In this context, the feed gas stream 12 comprises a product medium in a gaseous state in the form of gaseous hydrogen and the liquid product stream 15 comprises a product medium in a liquid state in the form of liquid hydrogen.

In order to provide cooling energy for cooling and liquefying the feed gas stream 12, the industrial hydrogen liquefaction plant is thermally coupled to a cooling system 20 comprising a precooling cycle 22 and a main cooling cycle 24 in form of closed-loop refrigeration cycles.

Further, for distributing liquefied hydrogen stored in the storage tank 18, the hydrogen liquefaction plant further comprises a filling device 26 for filling transport tanks 28 with liquid hydrogen stored in the storage tank 18. Specifically, the filling device 26 comprises a docking station 30 for releasably coupling at least one transport tank 28 to the filling device 26. The transport tank 28 may be provided in form of a tank trailer for use with trucks or trains.

The filling device 26 comprises a supply line 32 for supplying liquid hydrogen from the storage tank 18 to the transport tank 28. In the supply line 32, a throttle valve 34 is disposed for regulating a flow rate of a liquid hydrogen supply stream 36 flowing in direction of the transport tank 28.

Further, a first feed line 38 is provided in the filling device 26 for discharging gaseous hydrogen from the transport tank 28 to the storage tank 18. In the first feed line 38, a throttle valve 40 is disposed for regulating a flow rate of a first gaseous hydrogen feed stream 42 flowing in direction of the storage tank 18.

The storage tank 18 is configured to store hydrogen in its liquid and gaseous phase at a storage pressure in the range of 1 to 3.5 bar. A storage volume of the storage tank 18 is typically 10 times greater than a storage volume of the transport tank 28. The gaseous hydrogen discharged from the transport tank 28 may have a temperature of 31 K and a pressure up to 10 bar.

In case a pressure prevailing in the transport tank 28 is higher compared to a storage pressure prevailing in the storage tank 18, the filling device 26 may be operated in a first operational state, in which the throttle valve 34 disposed in the supply line 32 is in a closed position and the throttle valve 40 disposed in the first feed line 38 is in an open position. Thus, in this operational state, gaseous hydrogen is discharged from the transport tank 28 to the storage tank 18, wherein a supply of liquid hydrogen from the storage tank 18 to the transport tank 28 is suppressed. In this way, pressure equalization is provided such that the pressure prevailing in the transport tank 28 decreases, whereas the storage pressure prevailing in the storage tank 18 increases. When a desired adjustment between the pressure prevailing in the transport tank 28 and the storage pressure prevailing in the storage tank 18 is achieved, the throttle valve 34 is switched into an open position and liquid hydrogen stored in the storage tank 18 is supplied to the transport tank 28 either gravimetrically or supported by means of a feed pump 44 as depicted in FIG. 1. During the supply of liquid hydrogen into the transport tank 28, the throttle valve 40 in the first feed line 38 may remain in its open state.

Specifically, the first feed line 38 is configured to feed the gaseous hydrogen discharged from the transport tank 28 into the storage tank 18 downstream of the cooling and liquefying unit 10. More specifically, the first feed line 38 is configured to feed the gaseous hydrogen into the storage tank 18 in its gaseous state. In other words, the product medium discharged from the transport tank 28 via the first feed line 38 enters the storage tank 18 in its gaseous state.

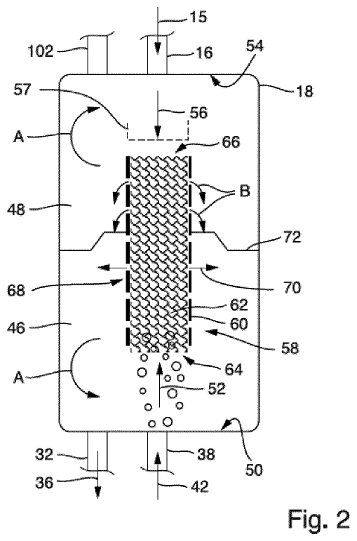

The process of discharging gaseous hydrogen from the transport tank 28 to the storage tank 18 is further specified with reference to FIG. 2.

In FIG. 2, an enlarged cross-sectional view on the first feed line 38 and the storage tank 18 is depicted. The storage tank 18 is configured to store hydrogen in a liquid phase 46 and a gaseous phase 48. The first feed line 38 is configured to open into the storage tank 18 such that the gaseous hydrogen discharged from the transport tank 28 is fed into the liquid phase of hydrogen 46 stored in the storage tank 18. More specifically, this is achieved by feeding the gaseous hydrogen discharged from the transport tank 28 into the storage tank 18 through a bottom 50 thereof. In other words, the first feed line 38 opens into the bottom 50 of the storage tank 18. At the bottom area of the storage tank 18, the storage tank 18 is provided with a downward reaching pipe 51 having a tubular shape with a cross-sectional area that is smaller compared to a portion of the storage tank arranged above and adjacent to the downward reaching pipe 51. Specifically, the first feed line 38 opens into the downward reaching pipe 51. The gaseous hydrogen discharged from the transport tank 28 and feed into the storage tank 18 interfuses or pervades the liquid phase of hydrogen 46. In this way, the gaseous hydrogen discharged into the storage tank 18 forms a stream 52 of gas bubbles rising within the storage tank 18. In order to generate a stream 52 of fine and distributed gas bubbles rising within the storage tank 18, the first feed line 38 is provided with a perforated outlet area 53 having a plurality of orifices, via which the gaseous hydrogen is fed into the storage tank 18.

The storage tank 18 further comprises a ceiling 54, into which the liquid product line 16 opens so as to supply liquid hydrogen generated by the cooling and liquefying unit 10 into the storage tank 18. Upon supplying liquid hydrogen into the storage tank 18 via the liquid product line 16, a stream 56 of falling or dripping liquid hydrogen within the storage tank 18 is formed. Optionally, for this stream 56, a liquid distributor 57 is installed, e. g. VKG type distributor from Sulzer, for distributing the stream 56 within the storage tank 18.

For distributively mixing the stream 52 of gaseous hydrogen with liquid hydrogen present in the storage tank 18, a static mixer 58 is disposed within the storage tank 18, i.e. in a storage space thereof accommodating the liquid phase 46 and the gaseous phase 48 of hydrogen. Specifically, the static mixer 58 is partially received within the downward reaching pipe 51 and configured to receive the stream 52 of gaseous hydrogen and to mix it with liquid hydrogen forming the liquid phase 46 and/or the stream 54 of liquid hydrogen supplied to the storage tank 18. In this configuration, the storage tank 18 comprises a connecting line 59 designed to fluid-communicatively connect a bottom portion of the downward reaching pipe 51 to a portion of the storage tank 18 above the downward reaching pipe 51.

Alternatively to the configuration depicted in FIGS. 1 and 2, the static mixer 58 may be arranged or accommodated outside of the storage tank 18, e.g. in the first feed line 38 upstream of and/or adjacent to the storage tank 18. This may have the effect, that the storage tank 18, which may be a vacuum tank, needs no manhole for maintenance, which would facilitate heat leakage.

The static mixer 58 comprises a housing 60 having a tubular shape which accommodates a mixer or corrugated structure 62, in particular in form of a plurality of grids and/or fins and/or a plurality of crossing channels. The mixer or corrugated structure 62 forms a mass transfer area for mixing the stream 52 of gaseous hydrogen with liquid hydrogen present in the storage tank 18, i.e. the stream 54 of liquid hydrogen within the storage tank 18. In other words, upon flowing through the mixer or corrugated structure 62, gaseous hydrogen fed into the storage tank 18 via the first feed line 38 is mixed with liquid hydrogen present in the storage tank 18.

The housing 60, at a first end face site thereof, is provided with a first feed opening 64 for feeding or guiding the stream 52 of gaseous hydrogen into the static mixer 58. Opposed to the first feed opening 64, the housing 60 is provided with a second feed opening 66 for feeding the stream 56 of liquid hydrogen into the static mixer 58.

Upon rising within the liquid phase 46, the gaseous hydrogen stream 52 enters the static mixer 58 and passes the mixer or corrugated structure 62, thereby being subjected to shear forces which eliminate coalescence. In this way, a distributively mixing of the gaseous hydrogen and the liquid hydrogen present in the storage tank 18 is achieved which supports the adjustment of a thermodynamic equilibrium within the storage tank 18.

Further, the housing 60 has a plurality of outflow openings 68 in form of through holes provided in a shell surface of the housing 60 between the first and the second feed opening 64, 66. The outflow openings 68 are configured for discharging a mixed stream 70 formed by mixing the stream 52 of gaseous hydrogen and the stream 56 of liquid hydrogen upon being guided through the mixer or corrugated structure 62. The outflow openings 68 are designed such that the liquid stream 70 induces convections within the liquid and gaseous phase 46, 48 in the storage tank 18 as indicated by arrows A in FIG. 2. Further, the outflow openings 68 are provided such that liquid hydrogen entering the static mixer 58 via the second feed opening 66 can be discharged via the outflow opening 68 above a liquid level 72 as indicated by arrows B in FIG. 2.

The storage tank 18 is arranged within the hydrogen liquefaction plant in an upright position. Accordingly, also the static mixer 58 is positioned within the storage tank 18 in an upright position such that the first feed opening 64 is positioned underneath the second feed opening 66.

In the following, the configuration of the hydrogen cooling and liquefying unit 10 is further specified under reference of FIG. 1. After entering the hydrogen cooling and liquefying unit 10, the feed gas stream 12 is guided through a first heat exchanger 74 so as to be precooled to a precooling temperature, e.g. 100 K, particularly by the precooling cycle 22. At the outlet of the first heat exchanger 74, residual impurities are removed from the precooled hydrogen feed gas 12 by means of adsorber vessels 76. Thereafter, the precooled feed gas stream 12 is routed back to the first heat exchanger 74 through a passage 78 filled with a catalyst. In this way, the precooled feed gas stream 12 is brought into contact with the catalyst being able to catalyze a conversion of ortho hydrogen to para hydrogen. In case of deuterium liquefaction, the para “isomer” is converted to ortho. Thereafter, the feed gas stream 12 successively passes a second heat exchangers 80, a third exchanger 82 and a fourth heat exchanger 84, i.e. through respective catalyst passages, prior to being supplied to an expansion device comprising a throttle valve 86 and an ejector 88.

After passing the ejector 88, the feed gas stream 12 is guided through a fifth heat exchanger 92 and a second expansion device with a throttle valve 94 so as to generate the liquid product stream 15 supplied to the storage tank 18.

The storage tank 18 is connected to the ejector 88 via a discharge line 102 for discharging and/or venting gaseous hydrogen from the storage tank 18 into the feed gas stream 12. In this configuration, the discharge line 102 is connected to a suction inlet of the ejector 88 so as to feed gaseous hydrogen into the feed gas stream 12.

In the following the cooling system 20 comprising the precooling cycle 22 and a main cooling cycle 24 in form of closed-loop refrigeration cycles are further specified.

It will be obvious to the skilled person that the present invention is not limited to this particular cooling system 20. Rather, the invention may be implemented in connection with various different cooling systems, for example, having a different number of compressor units and/or expansion devices in dependence on their capacity.

At first, the main cooling cycle 24 is described in more detail. In the main cooling cycle 20, a refrigerant circulates which comprises hydrogen as a cryogenic suitable gas, thereby successively passing a compressor unit 104, a precooling cold-box 106 and the main cooling cold-box 108.

Prior to entering the precooling cold-box 106, the refrigerant, upon flowing through a compressor system 110 within the compressor unit 104, is compressed to high pressure, thereby providing a refrigerant stream 112 flowing through a refrigerant line 114. For example, the refrigerant stream entering the precooling cold-box 106 may have a pressure smaller than 30 bar, in particular 25 bar, and an ambient temperature of 303 K. The pressure of the refrigerant stream entering the precooling cold-box 106 may be limited by the stability of the heat exchangers. For enabling a higher pressure level, the structural stability of the heat exchangers may be increased, i.e. by increasing the thickness of its walls which, however, may affect the heat conductivity thereof.

Thereafter, the refrigerant stream 112 is guided through the precooling cold-box 106, where it is precooled to a lower precooling temperature of, e.g., 80 K.

Upon entering the main cooling cold-box 108, the refrigerant stream 110 is divided, at different temperature levels, into a first partial stream 116 flowing through a first junction line 118 and a second partial stream 120 flowing through a second junction line 122. In the first and second junction line 118, 120, respectively, expansion devices 124, 126 are arranged configured to expand the first and the second partial stream 116, 120 so as to generate an expanded first and second partial stream 128, 130.

Downstream of the second junction line 122, the refrigerant stream 112 is further divided into a third partial stream 132 flowing through a third junction line 134 and a fourth partial stream 136 flowing through a fourth junction line 138. In the third junction line 134, the third partial stream 132 is expanded in expansion device 140 and thereby cooled. In this way, the high pressure third partial stream 132 is processed so as to generate a low pressure expanded third partial stream 142 with a pressure particularly between 1.1 bar to 8 bar and a temperature sufficiently low to ensure a proper cooling of the feed gas stream 12, e.g. between 20K and 24 K. Thereafter, the expanded third partial stream 132 is supplied to a gas liquid separator 144 arranged downstream of the expansion device 140 and configured to store the refrigerant in a liquid and gaseous phase. From the separator 144, the expanded third partial stream 142 comprising hydrogen in a liquid phase is guided through the fifth heat exchanger 92. Further, the gas phase from the separator 144 is taken directly to the suction part of ejector 146 via a further pipeline (not shown).

In this way, the fifth heat exchanger 92 is configured to transfer cooling energy from the expanded third partial stream 142 to the feed gas stream 12 to be cooled. More specifically, cooling energy is transferred from the expanded third partial stream 142 to the feed gas stream 12 such that the feed gas stream 12 is cooled to a temperature below the critical temperature of hydrogen, particularly below 24 K, thereby ensuring that the liquid product stream 15 is output from the hydrogen cooling and liquefying unit 10. At the same time, heat of reaction from the ortho para conversion is removed in every heat exchanger passage of the cooling and liquefying unit 10 following the absorber 76.

In the main cooling cycle 24, the cooling system 20 comprises a further ejector 146 having a propellant inlet and a suction inlet. After passing the fifth heat exchanger 92, the expanded third partial stream 142 is guided to the suction inlet of the further ejector 146. Further, the fourth partial stream 136, after being partially expanded in an expansion device 148 comprising a throttle valve and an expansion turbine, is guided to the propellant inlet of the further ejector 146. Accordingly, the suction inlet of the further ejector 146 is connected to the third junction line 134 for receiving the expanded third partial stream 142 and the propellant inlet of the further ejector 146 is connected to the fourth junction line 138 for receiving a partially expanded fourth partial stream 150. Compared to the expanded third partial stream 142, the partially expanded fourth partial stream 150 has an intermediate pressure level that is higher than the low pressure level of the expanded third partial stream 142.

Further, the filling device 26 comprises a third feed line 152 which is configured to feed the gaseous hydrogen discharged from the storage tank 18 into the main cooling cycle 24. Specifically, the third feed line 152 is configured to feed the gaseous hydrogen discharged from the storage tank 18 into the further ejector 146 via the suction inlet thereof. In the third feed line 152, a throttle valve 154 is disposed for regulating a flow rate of a third gaseous hydrogen feed stream 156 flowing in direction of the further ejector 146 through the third feed line 152.

In this configuration, the further ejector 146 functions as a pumping device which is driven by the partially expanded fourth partial stream 150 and configured to compress the expanded third partial stream 142 and/or the gaseous hydrogen supplied via the third feed line 152. More specifically, the partially expanded fourth partial stream 150 constitutes a propellant medium which, upon flowing through the further ejector 146 and due to a momentum transfer induced by the geometric configuration of the further ejector 146, suctions and thereafter compresses the expanded first partial stream 142 and/or the gaseous hydrogen supplied via the third feed line 152 which constitute a suction medium.

Upon expanding the partially expanded fourth partial stream 150 in the further ejector 146, the expanded third partial stream 142 and/or the gaseous hydrogen supplied via the third feed line 152 are/is compressed and merged with the partially expanded fourth partial stream 150, thereby generating an expanded refrigerant stream 158 output by the further ejector 146 into a recirculation line 160. Further, the expanded refrigerant stream 158 is then guided through the first to fourth heat exchanger 74, 80, 82, 84, thereby transferring cooling energy from the expanded refrigerant stream 158 to the feed gas stream 12.

The main cooling cycle 24 is connected to the feed gas stream 12 via a here not shown branch line so as to supply a refrigerant circulating in the main cooling cycle 24 and comprising hydrogen to the feed gas stream 12. Specifically, the branch line is designed such that it branches off from the third junction line 134 between the expansion device 140 and the separator 144 and opens into the discharge line 102. Further, the branch line has a throttle valve for regulating a flow rate therethrough. In this way, at least a part of the expanded third partial stream 142 can be feed into the suction inlet of the ejector 88 via the discharge line 102.

Furthermore, downstream of the adsorber vessels 76, a further branch line 162 is provided having a throttle valve 164, via which at least a part of the feed gas stream 12 can be branched off and supplied to the recirculating line 160 of the main cooling cycle 24.

Upon flowing through the recirculation line 160, the expanded refrigerant stream 158 together with the expanded first and second partial streams 128, 130 is guided successively through the compressor system 110 and a sixth heat exchanger 166. In this way, a closed cooling cycle is provided.

The sixth heat exchanger 166 is fed with a cooling water stream 168 and configured to transfer cooling energy from the cooling water stream 168 to the refrigerant stream 112.

Upon flowing through the precooling cold-box 106, the refrigerant stream 112 is precooled by means of the closed precooling cycle 22 which has a further refrigerant stream 170 comprising or consisting of nitrogen, i.e. in a liquid state. Specifically, the further refrigerant stream 170 is expanded in a expansion device 172 provided in form of a throttle valve prior to being successively supplied through a further gas liquid separator 174 and the first heat exchanger 74. Specifically, the first heat exchanger 74 is configured to transfer cooling energy from the further refrigerant stream 170 and the fluid flowing through the recirculation line 160 to the refrigerant stream 112 and the feed gas stream 12. By means of the further separator 174, the further refrigerant stream 170 is separated into a mainly gaseous phase and a mainly liquid phase, which are separately guided through the first heat exchanger 74.

It will be obvious for the person skilled in the art that these embodiments and items only depict examples of a plurality of possibilities. Hence, the embodiments shown here should not be understood to form a limitation of these features and configurations. Any possible combination and configuration of the described features can be chosen according to the scope of the invention.

### LIST OF REFERENCE NUMERALS

10 cooling and liquefying unit
12 feed gas stream
14 feed gas line
15 liquid product stream
16 liquid product line
18 storage tank
20 cooling system
22 pre-cooling cycle
24 main cooling cycle
26 filling device
28 transport tank
30 docking station
32 supply line
34 throttle valve
36 liquid hydrogen supply stream
38 first feed line
40 throttle valve
42 first gaseous hydrogen feed stream
44 feed pump
46 liquid phase of hydrogen stored in the storage tank
48 gaseous phase of hydrogen stored in the storage tank
50 bottom of the storage tank
51 downward reaching pipe of the storage tank
52 stream of rising hydrogen gas bubbles within the storage tank
53 perforated outlet area of the first feed line
54 ceiling of the storage tank
56 stream of falling liquid hydrogen within the storage tank
57 liquid distributer
58 static mixer
59 connecting line
60 housing
62 mixer or corrugated structure
64 first feed opening
66 second feed opening
68 outflow openings
70 liquid mixed stream discharged from the static mixer
72 liquid level
74 first heat exchanger
76 adsorber vessels
78 catalyst passage
80 second heat exchanger
82 third heat exchanger
84 fourth heat exchanger
86 first expansion device with throttle valve
88 ejector
92 fifth heat exchanger
94 second expansion device with throttle valve
102 discharge line
104 compressor unit
106 precooling cold-box
108 main cooling cold-box
110 compressor system
112 refrigerant stream
114 refrigerant line
116 first partial stream
118 first junction line
120 second partial stream
122 second junction line
124 expansion device
126 expansion device
128 expanded first partial stream
130 expanded second partial stream
132 third partial stream
134 third junction line
136 fourth partial stream
138 fourth junction line
140 expansion device
142 expanded third partial stream
144 separator
146 further ejector
148 expansion device
150 partially expanded fourth partial stream
152 third feed line
154 throttle valve
156 third gaseous hydrogen feed gas stream
158 expanded refrigerant stream
160 recirculation line
162 further branch line
164 throttle valve
166 sixth heat exchanger
168 cooling water stream
170 further
172 further refrigerant stream
174 further separator

1. Method for filling a transport tank with a product medium in a liquid state in a gas liquefaction plant, comprising a step of supplying the product medium in the liquid state from a storage tank of the gas liquefaction plant to the transport tank, wherein
the method further comprises a step of discharging the product medium in a gaseous state from the transport tank to the storage tank.

2. Method according to claim 1, wherein the product medium in the gaseous state stored in the transport tank is fed into the storage tank downstream of a cooling and liquefying unit of the gas liquefaction plant which generates a liquid product medium stream to be supplied to the storage tank.

3. Method according to claim 1, wherein the product medium in the gaseous state stored in the transport tank is fed into the storage tank in its gaseous state.

4. Method according to claim 1, wherein the storage tank stores the product medium in both a liquid and a gaseous phase, and the product medium in the gaseous state is discharged from the transport tank into the storage tank such that the product medium in the gaseous state is fed into the liquid phase.

5. Method according to claim 1, wherein the product medium in the gaseous state supplied to the storage tank from the transport tank is fed into a static mixer provided in or upstream of the storage tank.

6. Method according to claim 1, wherein the product medium in its gaseous state discharged from the transport tank is fed into a feed gas stream which, upon flowing through the cooling and liquefying unit, is to be liquefied and supplied to the storage tank, wherein the product medium in the gaseous state is fed into the feed gas stream downstream of a heat exchanger through which the feed gas stream is guided within the cooling and liquefying unit.

7. Method according to claim 1, wherein the product medium in its gaseous state stored in the transport tank is fed into a cooling cycle of the gas liquefaction plant for providing cooling energy for cooling and liquefying the feed gas stream flowing through the cooling and liquefying unit via an ejector arranged in the cooling cycle.

8. Method according to claim 7, wherein the cooling cycle is connected to the feed gas stream via a branch line so as to supply a refrigerant circulating in the cooling cycle and comprising the product medium to the feed gas stream.

9. Filling device for use in a gas liquefaction plant and for filling a transport tank with a product medium in a liquid state, having a supply line for supplying the product medium in the liquid state from a storage tank of the gas liquefaction plant to the transport tank, wherein
the filling device further comprises a feed line for discharging the product medium in a gaseous state from the transport tank to the storage tank.

10. Filling device according to claim 9, wherein the feed line is configured to feed the product medium in the gaseous state provided by the transport tank into the storage tank downstream of a cooling and liquefying unit of the gas liquefaction plant which is configured to generate a liquid product medium stream to be supplied to the storage tank, and/or the feed line is configured to feed the product medium in the gaseous state provided by the transport tank into the storage tank in its gaseous state.

11. Filling device according to claim 9, wherein the storage tank is configured to store the product medium in both a liquid and a gaseous phase, and the feed line is configured to open into the storage tank such that the product medium in the gaseous state is fed into the liquid phase.

12. Filling device according to claim 9, wherein a static mixer is provided which is configured to receive the product medium in the gaseous state discharged from the transport tank via the feed line and to mix it with the product medium in the liquid state stored in the storage tank, and wherein particularly the static mixer is accommodated at least partially in the storage tank and/or upstream of the storage tank in the feed line.

13. Filling device according to claim 12, wherein the static mixer is provided with a mixer structure accommodated in a housing provided with:
a first feed opening for feeding the product medium in the gaseous state discharged from the transport tank into the static mixer, and/or
a second feed opening for feeding the product medium in the liquid state supplied to the storage tank from the cooling and liquefying unit into the static mixer, and/or
at least one outflow opening, in particular for discharging a mixed stream formed by the product medium in the liquid state and the gaseous state upon flowing through the mixer structure.

14. Filling device according to claim 13, wherein the housing of the static mixer has a tubular shape in which opposing end faces thereof form the first feed opening and the second feed opening and the at least one outflow opening is provided in its shell surface, wherein in particular the static mixer is arranged in a upright position, in particular within or outside the storage tank, such that the first feed opening is arranged underneath the second feed opening.

15. Filling device according to claim 9, wherein the feed line is configured to feed the product medium in the gaseous state discharged from the transport tank into a feed gas stream which, upon flowing through the cooling and liquefying unit, is to be liquefied and supplied to the storage tank, and/or the feed line is configured to feed the product medium in the gaseous state discharged from storage tank into a cooling cycle of the gas liquefaction plant for providing cooling energy for cooling and liquefying the feed gas stream flowing through the cooling and liquefying unit.
